(19) United States
(12) Patent Application Publication
(10) Pub. No.: US 2026/0005564 A1
(43) Pub. Date: Jan. 1, 2026

(54) SYSTEMS FOR LAMINATION LAYERS OF A ROTOR

(71) Applicant: DANA TM4 INC., Boucherville (CA)

(72) Inventors: Rafaël BÉDARD, Otterburn Park (CA); Carl TRUDEL, Boucherville (CA); Benoit BLANCHARD ST-JACQUES, Boucherville (CA); Luke MILLER, Montreal (CA)

(21) Appl. No.: 19/249,947

(22) Filed: Jun. 25, 2025

Related U.S. Application Data
(60) Provisional application No. 63/665,578, filed on Jun. 28, 2024.

(51) Int. Cl. H02K 1/276

(52) U.S. Cl. CPC H02K 1/276

(57) ABSTRACT

Systems are provided for laminated layers of a rotor of an electric motor. A system includes an electric motor comprising a rotor, the rotor comprising alternating layers, where a plurality of first layers comprises a magnetic material and a plurality of second layers comprises the magnetic material and a non-magnetic material embedded in each of the plurality of second layers.

### CROSS REFERENCE TO RELATED APPLICATIONS

The present application claims priority to U.S. Provisional Application No. 63/665,578, entitled “SYSTEMS FOR LAMINATION LAYERS OF A ROTOR”, and filed on Jun. 28, 2024. The entire contents of the above-listed application are hereby incorporated by reference for all purposes.

### TECHNICAL FIELD

The present description relates generally to an electric motor, and more specifically to lamination layers of a rotor of the electric motor.

### BACKGROUND AND SUMMARY

A rotary electric machine may operate in a motoring mode, in which output is delivered to a coupled load, such as to one or more wheels or other moveable component of a vehicle, or a torque generating mode, in which machine rotation is used to generate electricity. The electric machine may include a cylindrical rotor including a stack of magnetic rotor lamination layers. The rotor may rotate with a rotor shaft when windings of a stator are energized by a power supply, which may include an energy storage device, such as a battery.

Rotors may be equipped with structural reinforcements due to high rotational speeds. However, in some examples, the structural reinforcements may impede functionality of an air gap of a lamination stacking factor of the rotor, wherein the impeded functionality may result in a loss of electromagnetic performance of the electric machine. Thus, there may be a demand for rotor systems different from those currently available.

The issues described above may be addressed by an electric motor comprising a rotor, the rotor comprising alternating layers, where a plurality of first layers comprises a magnetic material and a plurality of second layers comprises the magnetic material and a non-magnetic material embedded in each of the plurality of second layers.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a vehicle system;

FIG. 2 shows a pole of a rotor comprising a plurality of the pole;

FIG. 3A shows a plurality of layers of the rotor;

FIG. 3B shows a single pole of the rotor separated from other layers of the rotor;

FIG. 4 illustrates a first example of a support material arranged in a hybrid layer of the rotor;

FIG. 5 illustrates a second example of the first support material arranged in the hybrid layer of the rotor and a second support material arranged on a surface of the rotor, respectively;

FIG. 6 illustrates a third example of the first support material arranged in the hybrid layer of the rotor and the second support material arranged on the surface of the rotor, respectively;

FIG. 7 illustrates an alternative of the first example further including a thermal management device integrated into the support material;

FIG. 8 illustrates a fourth example of a first support material arranged in the layer of the rotor;

FIG. 9 illustrates fifth example of a first support material and a second support material arranged in the layer of the rotor; and

FIGS. 10A and 10B illustrates a second example of an adhesive location between hybrid and electromagnetic layers of the rotor.

### DETAILED DESCRIPTION

The following description relates to systems for a rotor of an electric motor. The rotor includes a structural reinforcement utilizing a skeleton structure. The skeleton structure may use a high strength material to support magnets and electromagnetic material (e.g., lamination steel) in the rotor. The rotor may include alternating layers between full electromagnetic material (e.g., lamination steel) layers and hybrid material layers. The hybrid material layers may include the high strength material skeleton structure combined with the electromagnetic material portion. The embodiments of the disclosure may position the electromagnetic material where desired for efficient rotor operation while reinforcing the rotor with non-magnetic and/or composite materials in other locations. The rotor is described in greater detail herein.

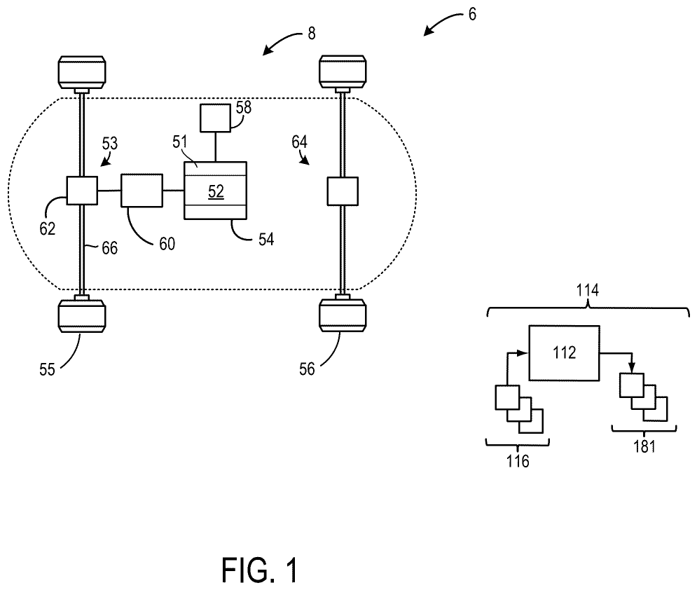

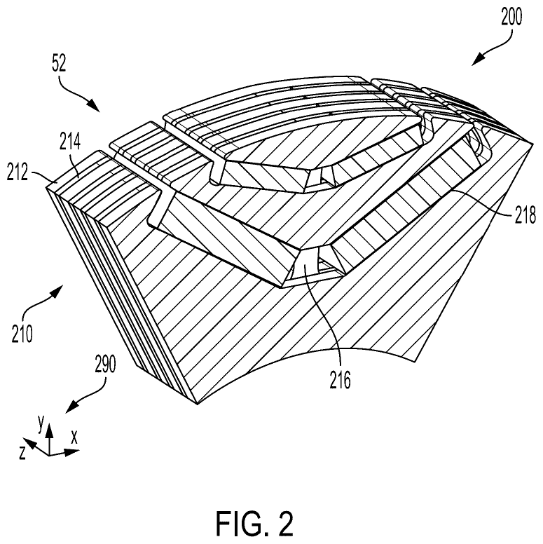

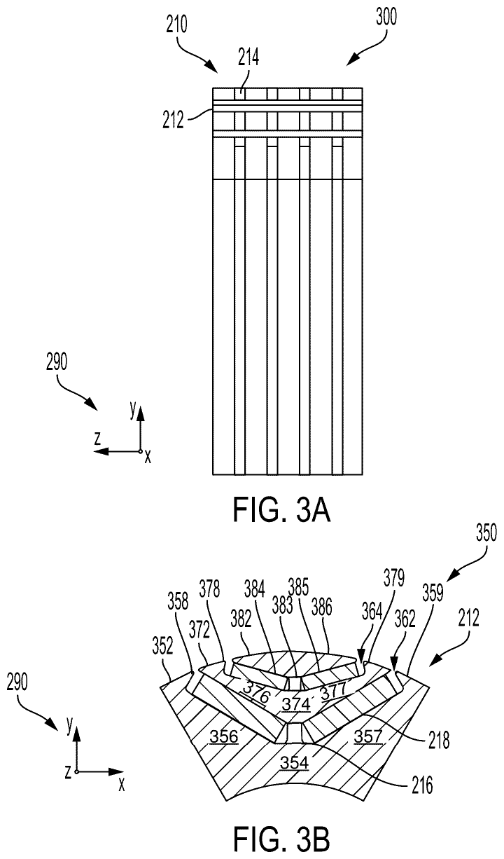

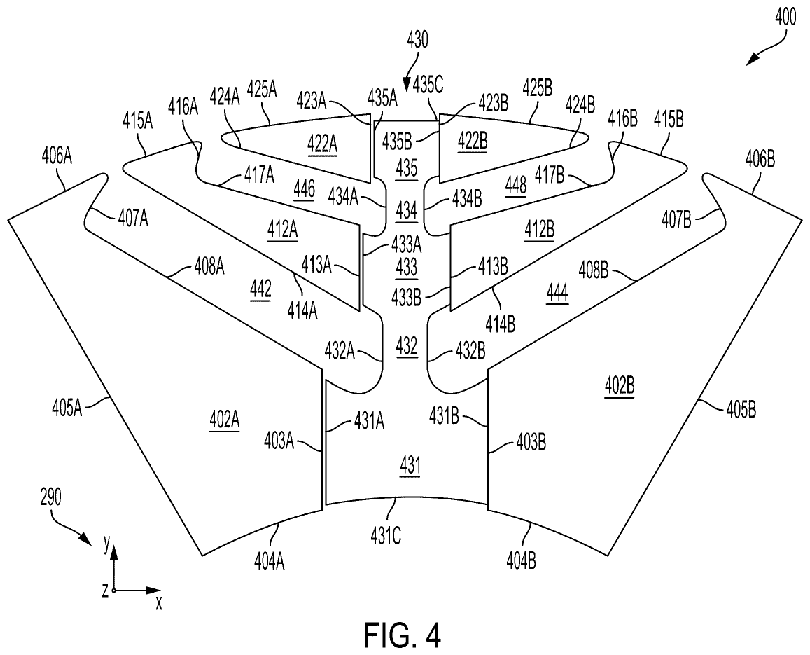

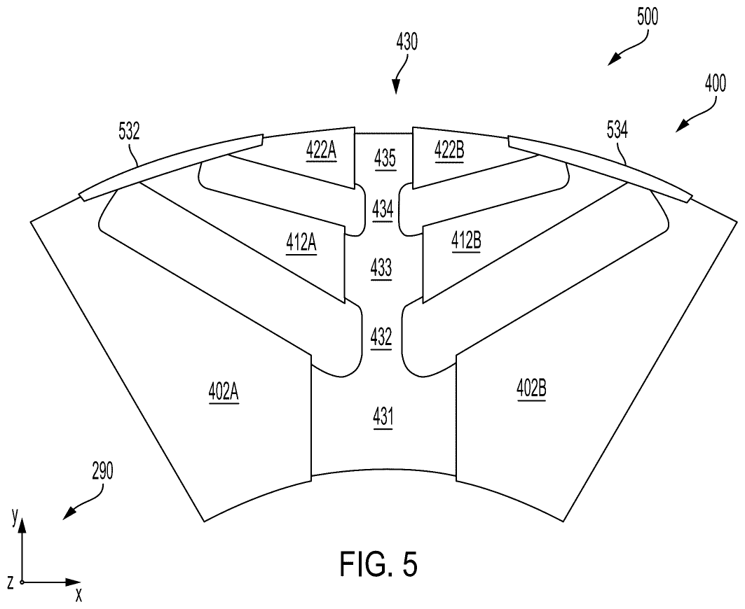

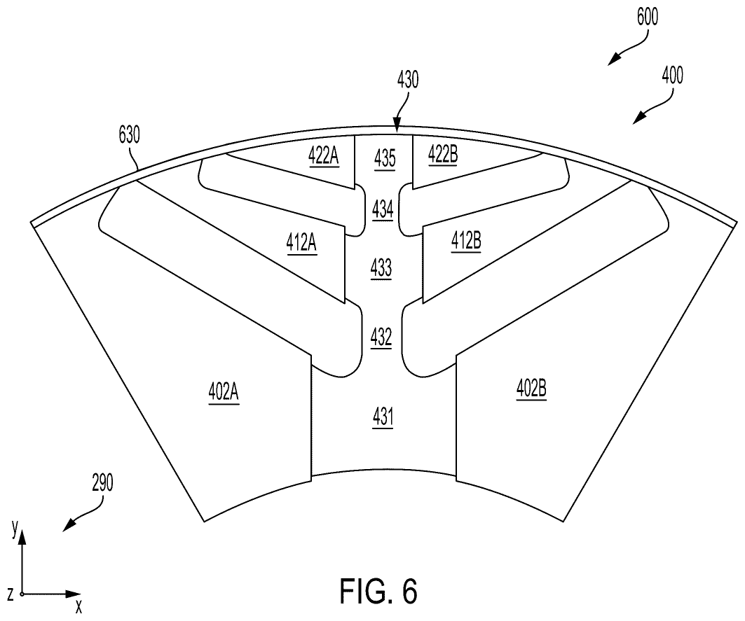

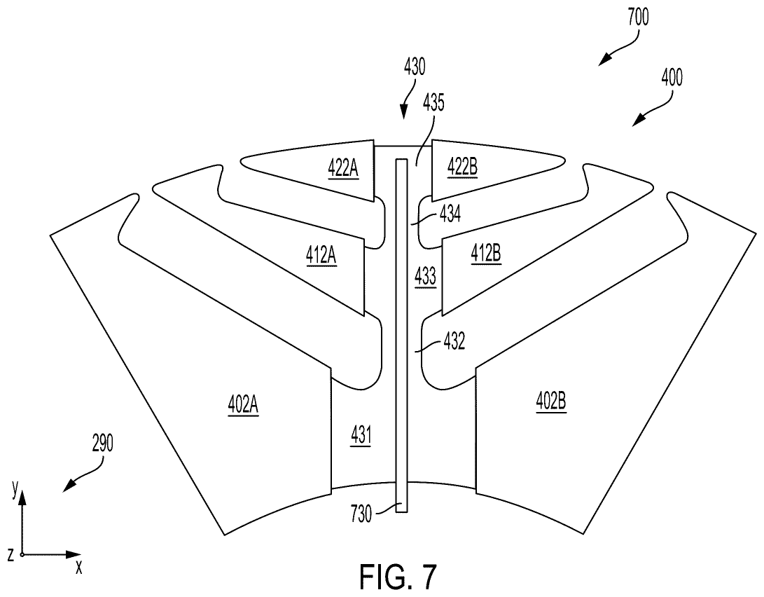

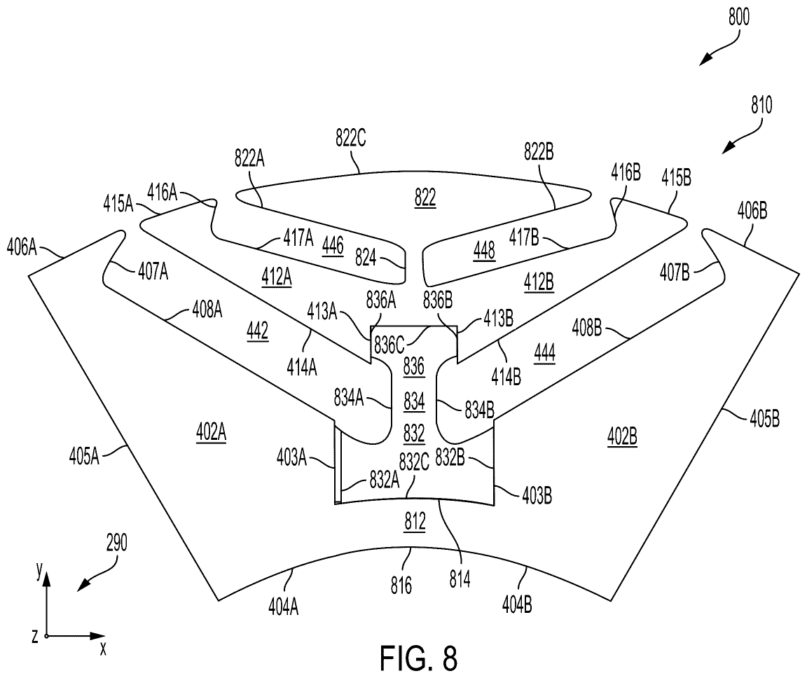

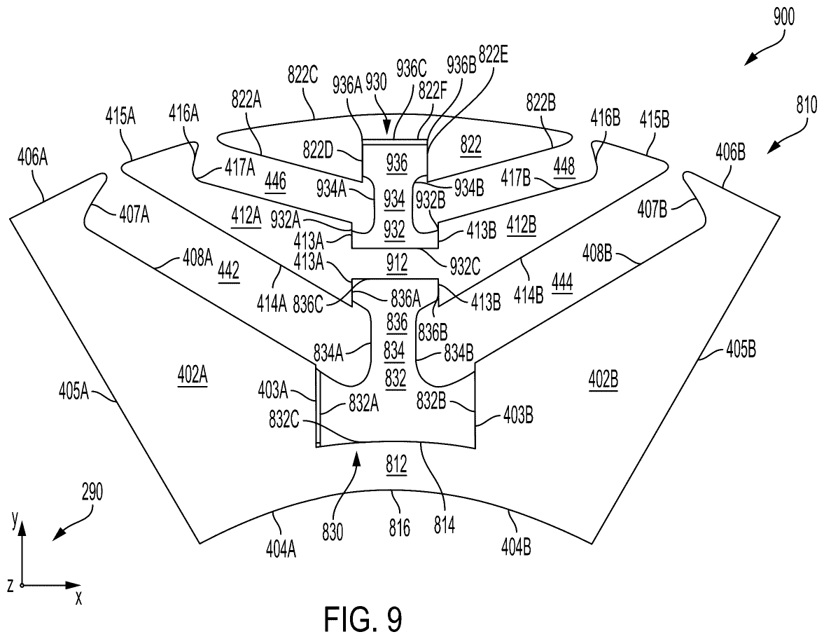

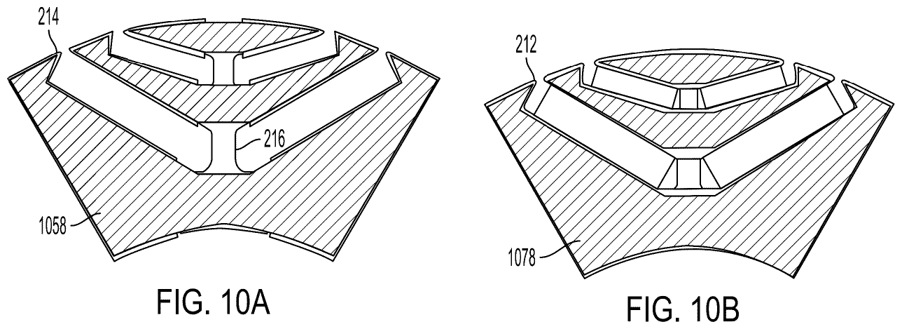

FIG. 1 shows an example of a vehicle system. FIG. 2 shows a pole of a rotor comprising a plurality of the pole. FIG. 3A shows a plurality of layers of the rotor. FIG. 3B shows a single pole of the rotor separated from other layers of the rotor. FIG. 4 illustrates a first example of a support material arranged in a layer of the rotor. FIG. 5 illustrates a second example of the first support material arranged in the hybrid layer of the rotor and a second support material arranged on a surface of the rotor, respectively. FIG. 6 illustrates a third example of the first support material arranged in the hybrid layer of the rotor and the second support material arranged on the surface of the rotor, respectively. FIG. 7 illustrates an alternative of the first example further including a thermal management device integrated into the support material. FIG. 8 illustrates a fourth example of a first support material arranged in the hybrid layer of the rotor. FIG. 9 illustrates fifth example of a first support material and a second support material arranged in the layer of the rotor. FIGS. 10A and 10B illustrate an example of an adhesive location between hybrid and electromagnetic layers of the rotor.

FIG. 1 shows a schematic depiction of a vehicle 6 with a powertrain 8 that may include a prime mover 54 and a transmission 60. The vehicle 6 may be a passenger vehicle, a commercial vehicle, a heavy-duty vehicle, an off-highway vehicle, an agricultural vehicle, a plane, a boat, or other vehicle system.

The prime mover 54 may be electrically connected to an energy storage device 58 (e.g., one or more traction batteries, capacitors, fuel cells, combinations thereof, and the like). Further, the prime mover 54 may be configured to operate as a generator, during selected conditions, to provide electrical power to charge the energy storage device 58, for example.

In one example, the prime mover 54 is an electric machine 54. The electric machine 54 may include a stator 51 surrounding a rotor 52. The stator 51 may receive power from the energy storage device 58, which may generate an electromagnetic field and cause the rotor 52 to rotate. A shaft may rotate in tandem with the rotor 52 and output power from the electric machine 54 to a gear of the transmission 60.

In some examples, the vehicle 6 may include an internal combustion engine (ICE) configured to operate in combination with or independently of the prime mover 54. In this way, the vehicle 6 may be configured as a hybrid vehicle in some examples.

In the illustrated example, the transmission 60 delivers mechanical power to a differential 62 of an axle assembly 53. However, it will be appreciated that the transmission 60 may additionally or alternatively deliver mechanical power to the other axle 64 in the vehicle 6. Still further, in other examples, the transmission may be incorporated into one of the axles to form an electric axle assembly. In the electric axle example, an internal combustion engine may provide mechanical power to the other axle, in some cases. The axle assembly 53 may include a lubrication system, as will be described in greater detail below.

The transmission 60 (e.g., a gearbox) may be configured to receive torque from the prime mover 54 via a shaft (e.g., a drive shaft) and/or other suitable mechanical components. The transmission 60 may output torque to the differential 62. The output torque may be moderated based on selective adjustments to gear engagement at the transmission 60 to accommodate desired vehicle operation. Torque from the transmission 60 may drive rotation of the differential 62, which may in turn drive rotation of axle shafts 66 which are rotationally coupled to vehicle wheels 55. Vehicle wheels 56 may rotate when vehicle wheels 55 are rotating against a surface.

A controller 112 may form a portion of a control system 114. The control system 114 is shown receiving information from sensors 116 and sending control signals to actuators 181. As one example, the sensors 116 may include sensors such as a battery level sensor, a clutch activation sensor, one or more position sensors of the electric motor, etc. The controller 112 may receive input data from the sensors, process the input data via a processor, and trigger the actuators in response to the processed input data based on instruction or code programmed therein corresponding to one or more routines.

Turning now to FIG. 2, it shows an embodiment 200 of a section of the rotor 52. As such, components previously introduced are similarly numbered in this and subsequent figures. The section illustrated in the embodiment 200 may be taken along a plane normal to an axis in which the rotor 52 rotates and includes a plurality of alternating layers 210. The plurality of alternating layers 210 may shape a rotor body of the rotor 52 and be configured to rotate in response to an electromagnetic field generated by a stator (e.g., stator 51 of FIG. 1). In one example, the rotor body comprises a cylindrical shape.

An axis system 290 is shown comprising an x-axis, a y-axis normal to the x-axis, and a z-axis normal to each of the x- and y-axes. In one example, the x-axis is parallel to a transverse direction, the y-axis is parallel to a vertical direction, and the z-axis is parallel to an axial direction. The rotor 52 may rotate about an axis parallel to the z-axis and the section may be taken along a plane parallel to the x-y plane.

The plurality of alternating layers 210 may include a first layer 212 and a second layer 214 alternating with one another. In one example, the first layer 212 is an electromagnetic layer and the second layer 214 is a hybrid layer. Herein, the first layer 212 is referred to interchangeably as the electromagnetic layer 212 and the second layer 214 is referred to interchangeably as the hybrid layer 214.

The electromagnetic layer 212 may include an electromagnetic material. In one example, the electromagnetic material may be laminated steel. The hybrid layer 214 may include a support element 216 and the electromagnetic material, such as the laminated steel. In one example, the support element 216 extends only within a plane of the hybrid layer 214. The support element 216 may be integrally arranged within the hybrid layer 214 and is in face-sharing contact with neighboring layers of the electromagnetic layer 212. The support element 216 may be embedded within the hybrid layer 214 and extends in the radial direction. In one example, the hybrid layer 214 may be identical to the electromagnetic layer 212 apart from the inclusion of the support element 216. The support element 216 is described in greater detail below.

The electromagnetic layer 212 and the hybrid layer 214 may alternate with one another. The electromagnetic layer 212 and the hybrid layer 214 may alternate with one another in the axial direction.

As such, each iteration of the electromagnetic layer 212 is in face-sharing contact with the hybrid layer 214 and does not contact a different iteration of the electromagnetic layer 212. Similarly, each iteration of the hybrid layer 214 is in face-sharing contact with the electromagnetic layer 212 and does not contact another iteration of the hybrid layer 214. In this way, the two layers are interleaved with one another. An orientation of each layer of the electromagnetic layer 212 and the hybrid layer 214 may be identical, wherein each layer extends in a radial direction, normal to the axial direction. In one example, the layers are uniform in the radial direction and alternate in only the axial direction.

The electromagnetic layer 212 and the hybrid layer 214 may include one or more cutouts in which a plurality of magnets 218 may be arranged. The plurality of magnets 218 may be configured to respond to the electromagnetic field generated by the stator and rotate the rotor 52. The plurality of magnets 218 are described in greater detail with respect to FIG. 3B. It will be appreciated that the support element and the alternating hybrid and magnetic layers may be used in different rotor and motor topologies and are not limited to the use of magnetic materials.

Turning now to FIG. 3A, it shows a side view 300 of the plurality of alternating layers 210. As illustrated, neighboring layers are in face-sharing contact with one another. Each individual layer of the electromagnetic layer 212 or the hybrid layer 214 extends in the axial direction uninterrupted by the other layer.

FIGS. 10A and 10B illustrate an example adhesive location for joining neighboring layers of the plurality of alternating layers 210. Therein, a first plurality of adhesives 1058 may be arranged on the hybrid layer 214. The first plurality of adhesives 1058 may be shaped to match a shape of the hybrid layer 214. As such, each of the first plurality of adhesives 1058 may cover the hybrid layer 214 and at least a portion of its support element 216. In one example, sections of the support element 216 arranged between cutouts of the hybrid layer 214 may not be covered with an adhesive of the first plurality of adhesives 1058.

A second plurality of adhesives 1078 may be arranged on the electromagnetic layer 212. The second plurality of adhesives 1078 may be shaped to match a shape of the electromagnetic layer 212. As such, each of the second plurality of adhesives 1078 may cover the electromagnetic layer 212. The plurality of magnets 218 and the cutouts of the electromagnetic layer 212 may not be covered by the second plurality of adhesives. As such, when the electromagnetic layer 212 is aligned with and pressed against the hybrid layer 214, the first plurality of adhesives 1058 and the second plurality of adhesives 1078 may physically couple with one another. In some examples, additionally or alternatively, the plurality of alternating layers 210 may be bonded together.

In this way, the first plurality of adhesives 1058 and the second plurality of adhesives 1078 may be arranged on faces of the electromagnetic layer 212 and the hybrid layer 214 parallel to the radial direction, respectively. As such, when the faces of the electromagnetic layer 212 and the hybrid layer 214 are pressed together, a seal may be formed and the adhesives may form a permanent bond that blocks separation of the two layers. There may be no other couplings or fasteners that retain the two layers together. Thus, the first plurality of adhesives 1058 and the second plurality of adhesives 1078 are the only coupling elements joining the electromagnetic layer 212 to the hybrid layer 214.

Turning now to FIG. 3B, it shows an embodiment 350 of a single layer (e.g., a single pole) of the rotor (e.g., rotor 52 of FIG. 1). In one example, a single layer of the electromagnetic layer 212 is shown from a face-on vantage parallel to the axial direction of the rotor. The electromagnetic layer 212 may include a first body 352, a second body 372, and a third body 382. The support element 216 is exposed through an air gap between the first body 352 and the second body 372 and between the second body 372 and the third body 382. The support element 216 may be arranged in a plane parallel to and outside of a plane of the electromagnetic layer 212. As such, the support element 216 is parallel to the electromagnetic layer 212. In this way, the support element 216 shown in FIG. 3B is included in a neighboring hybrid layer in face-sharing contact with the electromagnetic layer 212 illustrated in FIG. 3B. The support element 216 is not included in the electromagnetic layer 212.

The first body 352 may be separated from the second body 372 via a first air gap 362. The second body 372 may be separated from the third body 382 via a second air gap 364. In this way, the electromagnetic layer 212 may include three distinct portions separated from one another via the air gaps.

The first body 352 may include a C shape with prongs 358 and 359 at extreme ends thereof. That is, the first body 352 may include two extreme ends spaced apart from one another, the extreme ends connected to arms 356, 357 extending from a curved body 354. A width of the arms 356, 357 may increase in a direction away from the extreme ends. The extreme ends may include prongs 358 and 359 that point toward the second body 372. The shape of the first body 352 is described in greater detail below.

The second body 372 may include a V-shape with prongs 378, 379 at extreme ends thereof. That is, the second body 372 may include two extreme ends spaced apart from one another, the extreme ends connected to arms 376, 377 extending from a central body 374. A width of the arms 376, 377 may increase in a direction away from the extreme ends. The extreme ends may include prongs 378, 379 that point toward the third body 382.

The third body 382 may include a curved trapezoid shape. The curved trapezoid shape may include a linear top 383, a linear first angled side 384, and a linear second angled side 385, wherein the angled sides join with a curved base 386 at separate curved edges. The curved base 386 may face a direction away from the second body 372. As such, the linear top 383 may face a direction toward the second body 372 and may be closer to the second body 372 than the curved base.

The plurality of magnets 218 may be arranged within the first air gap 362 and the second air gap 364. The plurality of magnets 218 within the first air gap 362 may be identical in shape and size to the plurality of magnets 218 in the second air gap 364. Additionally, or alternatively, the plurality of magnets 218 in the first air gap 362 may be different in shape, size, and/or orientation to the plurality of magnets 218 in the second air gap 364. As illustrated, the plurality of magnets 218 do not obscure a view of the support element 216 along the z-axis.

Turning now to FIG. 4, it shows a first example of a hybrid layer 400. The hybrid layer 400 may be identical to the hybrid layer 214 of FIG. 2. The hybrid layer 400 may include a plurality of bodies interconnected via a supporting element 430. The supporting element 430 may be identical to the support element 216 of FIG. 2.

The plurality of bodies may include a first pair of bodies, a second pair of bodies, and a third pair of bodies. The first pair of bodies may include a first body 402A and a second body 402B. The second pair of bodies may include a third body 412A and a fourth body 412B. The third pair of bodies may include a fifth body 422A and a sixth body 422B. Each body of a pair of bodies may be mirror copies of one another. For example, the first body 402A is a mirror copy of the second body 402B. The third body 412A is a mirror copy of the fourth body 412B. The fifth body 422A is a mirror copy of the sixth body 422B.

The first body 402A may include a first side 403A, a second side 404A, a third side 405A, a fourth side 406A, a fifth side 407A, and a sixth side 408A. The first side 403A may be angled to the sixth side 408A and the second side 404A. The second side 404A may be curved and extend from the first side 403A to the third side 405A. The third side 405A may be linear and extend to the fourth side 406A. In one example, the third side 405A is the largest side of the first body 402A. The fourth side 406A may be substantially normal to the third side 405A and extend to the fifth side 407A. The fifth side 407A and the fourth side 406A may shape a tine of the first body 402A. The sixth side 408A extends from the fifth side 407A to the first side 403A. The sixth side 408A is approximately normal to the fifth side 407A and obtusely angled to the first side 403A.

The second body 402B may include a first side 403B, a second side 404B, a third side 405B, a fourth side 406B, a fifth side 407B, and a sixth side 408B. The first side 403B, the second side 404B, the third side 405B, the fourth side 406B, the fifth side 407B, and the sixth side 408B are identical to and may mirror the first side 403A, the second side 404A, the third side 405A, the fourth side 406A, the fifth side 407A, and the sixth side 408A of the first body 402A, respectively.

The supporting element 430 may be physically coupled to the first side 403A of the first body 402A and the first side 403B of the second body 402B at a first section 431. The first section 431 may include a first side 431A in face-sharing contact with the first side 403A and a second side 431B in face-sharing contact with the first side 403B. A curved base 431C may extend between the first side 431A and the second side 431B and match a curvature of the second side 404A and the second side 404B.

A first air gap 442 may be arranged between the first body 402A and the third body 412A. A second air gap 444 may be arranged between the second body 402B and the fourth body 412B. A second section 432 of the supporting element 430 may be adjacent to the first air gap 442 and the second air gap 444. The second section 432 may include a reduced width relative to the first section 431, the width measured along the x-axis. The second section 432 may include a first side 432A and a second side 432B. The first side 432A and the second side 432B may include a J-shape. That is to say, the first side 432A and the second side 432B may include a curved shape, such as a concave shape, which may increase a size of the first air gap 442 and the second air gap 444. The first side 432A may extend from the first side 431A of the first section 431 to a first side 433A of a third section 433 of the supporting element 430. The second side 432B may extend from the second side 431B of the first section 431 to a second side 433B of the third section 433.

The first side 433A of the third section 433 may be in face-sharing contact with a first side 413A of the third body 412A. A second side 414A may extend from the first side 413A at an angle less than perpendicular. Each of the first side 413A and the second side 414A may be linear, wherein a length of the second side 414A is greater than a length of the first side 413A. A third side 415A may extend from the second side 414A at an angled less than perpendicular. The third side 415A may join with a fourth side 416A at an acute angle and shape a tine of the third body 412A. The tine of the third body 412A may point in a similar direction as the tine of the first body 402A, wherein each point toward the fifth body 422A.

A fifth side 417A may extend from the fourth side 416A at a substantially perpendicular angle and join with the first side 413A at an angle greater than perpendicular. The fourth body 412B may include a first side 413B, a second side 414B, a third side 415B, a fourth side 416B, and a fifth side 417B are identical to and mirror the first side 413A, the second side 414A, the third side 415A, the fourth side 416A, and the fifth side 417A, respectively. The first side 413B of the fourth body 412B may be in face-sharing contact with the second side 433B of the third section 433.

A third air gap 446 may be arranged between the third body 412A and the fifth body 422A. A fourth air gap 448 may be arranged between the fourth body 412B and the sixth body 422B. A fourth section 434 of the supporting element 430 may be adjacent to the third air gap 446 and the fourth air gap 448. The fourth section 434 may include a reduced width relative to the first section 431 and the third section 433. A width of the third section 433 may be less than a width the first section 431.

The fourth section 434 may include a first side 434A and a second side 434B. The first side 434A and the second side 434B may include a J-shape. That is to say, the first side 434A and the second side 434B may include a curved shape, such as a concave shape, which may increase a size of the third air gap 446 and the fourth air gap 448. The first side 434A may extend from the first side 433A of the third section 433 to a first side 435A of a fifth section 435 of the supporting element 430. The second side 434B may extend from the second side 433B of the third section 433 to a second side 435B of the fifth section 435. A third side 435C may linearly extend from the first side 435A to the second side 435B. A width of the fifth section 435 may be greater than widths of the fourth section 434 and the second section 432. The width of the fifth section 435 may be less than the third section 433 and the first section 431.

The first side 435A may be in face-sharing contact with a first side 423A of the fifth body 422A. A second side 424A may extend at an acute angle from the first side 423A. A third side 425A may extend at an acute angle from the second side 424A and at a perpendicular angle from the first side 423A. The third side 425A may be curved. The first side 423A and the second side 424A may be linear. The sixth body 422B may include a first side 423B, a second side 424B, and a third side 425B that are identical to and mirror the first side 423A, the second side 424B, and the third side 425B of the fifth body 422A, respectively.

The supporting element 430 may be centrally located within the hybrid layer 400. As such, the supporting element 430 may be distal to outer sides of the bodies, such as the third side 405A, the third side 405B, the fourth side 406A, the fourth side 406B, the third side 415A, and the third side 415B. The supporting element 430 and the hybrid layer 400 may form a single contiguous piece. The non-magnetic material (e.g., the supporting element 430) comprises a symmetric shape with a reduced width adjacent to air gaps of the plurality of second layers. In some examples, the width may be larger. It will be appreciated that the third side 405A and the third side 405B are illustrated as edges for clarity in the present application. The third sides 405A and 405B may repeat cyclically to form a 360 degree rotor.

Turning now to FIG. 5, it shows a second example 500 of the hybrid layer 400. The second example 500 may be differentiated from the first example of FIG. 4 in that the second example 500 further comprises a second supporting element 532 and a third supporting element 534 arranged along an outer portion and/or a perimeter of the hybrid layer 400. In one example, such as the second example 500, the supporting element 430 is a first supporting element. The second supporting element 532 may be coupled the fourth side 406A of the first body 402A, the third side 415A of the third body 412A, and the third side 425A of the fifth body 422A of FIG. 4. The third supporting element 534 may be coupled the fourth side 406B of the second body 402B, the third side 415B of the fourth body 412B, and the third side 425B of the sixth body 422B of FIG. 4. The second supporting element 532 and the third supporting element 534 may not touch the supporting element 430.

The supporting element 430, the second supporting element 532, and the third supporting element 534 may include identical materials, such as a carbon fiber composite. Additionally, or alternatively, the supporting element 430, the second supporting element 532, and the third supporting element 534 may include a different non-magnetic material configured to provide a desired rigidity and strength to the hybrid layer 400. In one example, one or more of the supporting element 430, the second supporting element 532, and the third supporting element 534 may include a mixture or layers of a rigid material, such as the carbon fiber composite along with a thermally conductive material, such as graphite. In this way, cooling and/or heating may be provided through a section of the supporting element 430, the second supporting element 532, and/or the third supporting element 534.

Turning now to FIG. 6, it shows a third example 600 of the hybrid layer 400. The third example 600 may be differentiated from the first example of FIG. 4 and the second example 500 of FIG. 5 in that the third example 600 comprises a second supporting element 630. The second supporting element 630 may be coupled the fourth side 406A of the first body 402A, the third side 415A of the third body 412A, the third side 425A of the fifth body 422A, the fourth side 406B of the second body 402B, the third side 415B of the fourth body 412B, the third side 425B of the sixth body 422B, and the third side 435C of the fifth section 435 of the supporting element 430. The second supporting element 630 may be in face-sharing contact with the supporting element 430. In one example, the second supporting element 630 may wrap around an entirety of the rotor.

The supporting element 430 and the second supporting element 630 may include identical materials, such as a carbon fiber composite. Additionally, or alternatively, the supporting element 430 and the second supporting element 630 may include a different non-magnetic material configured to provide a desired rigidity to the hybrid layer 400.

Turning now to FIG. 7, it shows a fourth example 700 of the hybrid layer 400. The fourth example 700 may be differentiated from the first through third examples of FIGS. 4-6, respectively, in that the fourth example 700 includes a heat transfer element 730 embedded in the supporting element 430. The heat transfer element 730 may include a conduit for conducting a fluid. Additionally, or alternatively, the heat transfer element 730 may include thermally conductive materials. In this way, cooling and/or heating may be provided through a section of the supporting element 430, which may enhance rotor temperature control.

Turning now to FIG. 8, it shows a fifth example 800 of a hybrid layer 810. The hybrid layer 810 may include the first body 402A physically coupled to the second body 402B via a supporting element 830 and a bridge 812. The bridge 812 may extend from the first side 403A of the first body 402A to the first side 403B of the second body 402B. The bridge 812 may include a top side 814 that extends from the first side 403A to the first side 403B. The bridge 812 may further include a bottom side 816 that extends from the second side 404A and the second side 404B. The bottom side 816 may include a curvature that is complementary to a curvature of the second side 404A and the second side 404B such that a radius of curvature is uniform. In one example, the first body 402A, the second body 402B, and the bridge 812 are a single piece.

The supporting element 830 may include a first section 832 that includes a first side 832A that is in face-sharing contact with the first side 403A. The first section 832 may further include a second side 832B that is in face-sharing contact with the first side 403B. The first section 832 may further include a third side 832C, that is curved and extends from the first side 403A to the first side 403B and is in face-sharing contact with the top side 814 of the bridge 812.

The supporting element 830 may further include a second section 834 including a first side 834A and a second side 834B. The first side 834A and the second side 834B may include a J-shaped curved. Additionally, or alternatively, the first side 834A and the second side 834B may be recessed to increase a size of the first air gap 442 and the second air gap 444, respectively.

The supporting element 830 may further include a third section 836. The third section 836 may include a first side 836A in face sharing contact with the first side 413A of the third body 412A. The third section 836 may further include a second side 836B, parallel to the first side 836A, and in face-sharing contact with the first side 413B of the fourth body 412B. A top side 836C of the third section 836 may be in face-sharing contact with a bridge 824 that interconnects the third body 412A to the fourth body 412B. The bridge 824 may interconnect the bridge 824 to a fifth body 822. The fifth body 822 may include a first surface 822A that faces the third air gap 446 between the first surface 822A and the fifth side 417A. The fifth body 822 may further include a second side 822B that faces the fourth air gap between the second side 822B and the fifth side 417B. The fifth body 822 may further include a third surface 822C that curves and matches an arc shape of the fourth side 406A, the fourth side 406B, the third side 415A, and the third side 415B.

In one example, the first body 402A, the second body 402B, the third body 412A, the fourth body 412B, the fifth body 822, and the supporting element 830 are a single, contiguous piece. In some examples, additionally or alternatively, the fifth example 800 may include additional support elements coupled to one or more of the fourth side 406A, the fourth side 406B, the third side 415A, and the third side 415B.

Turning now to FIG. 9, it shows a sixth example 900 of the hybrid layer 810. The sixth example 900 may alter the hybrid layer 810 relative to the fifth example 800 of FIG. 8, in that the fifth body 822 is interconnected to a bridge 912 via a second supporting element 930. That is to say, the third body 412A and the fourth body 412B may be interconnected by the bridge 912.

A second supporting element 930, may be shaped similarly to the supporting element 830. In one example, the second supporting element 930 may be smaller than the supporting element 830. The second supporting element 930 may be coupled to an opposite side of the bridge 912 relative to the supporting element 830. In one example, the bridge 912 may separate the supporting element 830 from the second supporting element 930. In this way, the non-magnetic material is discontinuous and positioned at different areas of the hybrid layer 810.

The second supporting element 930 may include a first section 932 with a first side 932A in face-sharing contact with the first side 413A of the third body 412A. The second supporting element 930 may further include a second side 932B parallel with the first side 932A and in face-sharing contact with the first side 413B of the fourth body 412B. The second supporting element 930 may further include a third side 932C that is in face-sharing contact with the bridge, the third side 932C normal to and extending from the first side 932A and the second side 932B.

The second supporting element 930 may further include a second section 934 comprising a first side 934A and a second side 934B. The first side 934A may face the third air gap 446 and include a concave shape. The second side 934B may face the fourth air gap 448 and include a concave shape.

The second supporting element 930 may further include a third section 936 including a first side 936A in face-sharing contact with a fourth side 822D of the fifth body 822. The third section 936 may further include a second side 936B in face-sharing contact with a fifth side 822E of the fifth body 822. The third section 936 may further include a third side 936C in face-sharing contact with a sixth side 822F of the fifth body 822. The sixth side 822F may be normal to the fourth side 822D and the fifth side 822E.

The first body 402A, the second body 402B, the supporting element 830, the third body 412A, the fourth body 412B, the second supporting element 930, and the fifth body 822 may be a single, contiguous piece. The sixth example 900 may further include additional supporting elements and/or thermal features similar to the examples shown in FIGS. 5-7.

FIGS. 1-10B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-10B are shown approximately to scale.

The disclosure also provides support for a system including an electric motor comprising a rotor, the rotor comprising alternating layers, where a plurality of first layers comprises a magnetic material and a plurality of second layers comprises the magnetic material and a non-magnetic material embedded in each of the plurality of second layers. In a first example of the system, the magnetic material is laminated steel. In a second example of the system, optionally including the first example, the non-magnetic material is a carbon fiber composite. In a third example of the system, optionally including one or both of the first and second examples, the alternating layers are bonded via an adhesive. In a fourth example of the system, optionally including one or more or each of the first through third examples, the non-magnetic material comprises a thermal conductive element. In a fifth example of the system, optionally including one or more or each of the first through fourth examples, the non-magnetic material is physically coupled to separate portions of the magnetic material of a second layer of the plurality of second layers. In a sixth example of the system, optionally including one or more or each of the first through fifth examples, the non-magnetic material is discontinuous and positioned at different areas of a second layer of the plurality of second layers.

The disclosure also provides support for a rotor for an electric motor including a plurality of first layers alternating with a plurality of second layers, each first layer of the plurality of first layers comprising only a magnetic material, and each second layer of the plurality of second layers comprises the magnetic material and a non-magnetic material connecting separate pieces of the magnetic material. In a first example of the system, the non-magnetic material is embedded with the magnetic material of the plurality of second layers. In a second example of the system, optionally including the first example, a thermal conductive material is embedded into the non-magnetic material. In a third example of the system, optionally including one or both of the first and second examples, the non-magnetic material is centrally or radially positioned within the plurality of second layers. In a fourth example of the system, optionally including one or more or each of the first through third examples, the non-magnetic material is positioned along an outer perimeter of the plurality of second layers. In a fifth example of the system, optionally including one or more or each of the first through fourth examples, the non-magnetic material is bonded to the magnetic material. In a sixth example of the system, optionally including one or more or each of the first through fifth examples, the non-magnetic material surrounds an entire circumference of the rotor. In a seventh example of the system, optionally including one or more or each of the first through sixth examples, the plurality of second layers are identical in shape and size to the plurality of first layers.

The disclosure also provides support for an electric motor including a plurality of first layers comprising a magnetic material, and a plurality of second layers comprising the magnetic material and a non-magnetic material bonded to the magnetic material, wherein the plurality of first layers interleaves with the plurality of second layers. In a first example of the system, each first layer of the plurality of first layers is a single piece, and wherein each second layer of the plurality of second layers is a contiguous piece comprising multiple pieces of the magnetic material bonded to at least one piece of the non-magnetic material. In a second example of the system, optionally including the first example, the non-magnetic material is one or more pieces and arranged along a central portion and an outer portion of the plurality of second layers. In a third example of the system, optionally including one or both of the first and second examples, the plurality of first layers and the plurality of second layers are identical in shape and size. In a fourth example of the system, optionally including one or more or each of the first through third examples, the non-magnetic material at least partially surrounds a circumference of the plurality of first layers and the plurality of second layers.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
an electric motor comprising a rotor, the rotor comprising alternating layers, where a plurality of first layers comprises a magnetic material and a plurality of second layers comprises the magnetic material and a non-magnetic material embedded in each of the plurality of second layers.

2. The system of claim 1, wherein the magnetic material is laminated steel.

3. The system of claim 1, wherein the non-magnetic material is a carbon fiber composite.

4. The system of claim 1, wherein the alternating layers are bonded via an adhesive.

5. The system of claim 1, wherein the non-magnetic material comprises a thermally conductive element.

6. The system of claim 1, wherein the non-magnetic material is physically coupled to separate portions of the magnetic material of a second layer of the plurality of second layers.

7. The system of claim 1, wherein the non-magnetic material is discontinuous and positioned at different areas of a second layer of the plurality of second layers.

8. A rotor for an electric motor, comprising:
a plurality of first layers alternating with a plurality of second layers, each first layer of the plurality of first layers comprising only a magnetic material, and each second layer of the plurality of second layers comprises the magnetic material and a non-magnetic material connecting separate pieces of the magnetic material.

9. The rotor of claim 8, wherein the non-magnetic material is embedded with the magnetic material of the plurality of second layers.

10. The rotor of claim 8, wherein a thermal conductive material is embedded into the non-magnetic material.

11. The rotor of claim 8, wherein the non-magnetic material is centrally or radially positioned within the plurality of second layers.

12. The rotor of claim 8, wherein the non-magnetic material is positioned along an outer perimeter of the plurality of second layers.

13. The rotor of claim 8, wherein the non-magnetic material is bonded to the magnetic material.

14. The rotor of claim 8, wherein the non-magnetic material surrounds an entire circumference of the rotor.

15. The rotor of claim 8, wherein the plurality of second layers are identical in shape and size to the plurality of first layers.

16. An electric motor, comprising:
a plurality of first layers comprising a magnetic material; and
a plurality of second layers comprising the magnetic material and a non-magnetic material bonded to the magnetic material; wherein
the plurality of first layers interleaves with the plurality of second layers.

17. The electric motor of claim 16, wherein each first layer of the plurality of first layers is a single piece, and wherein each second layer of the plurality of second layers is a contiguous piece comprising multiple pieces of the magnetic material bonded to at least one piece of the non-magnetic material.

18. The electric motor of claim 16, wherein the non-magnetic material is one or more pieces and arranged along a central portion and an outer portion of the plurality of second layers.

19. The electric motor of claim 16, wherein the plurality of first layers and the plurality of second layers are identical in shape and size.

20. The electric motor of claim 16, wherein the non-magnetic material at least partially surrounds a circumference of the plurality of first layers and the plurality of second layers.
